(19) United States
(12) Patent Application Publication
(10) Pub. No.: US 2021/0123549 A1
(43) Pub. Date: Apr. 29, 2021

(54) CLOTHES DRYER VENT CONNECTOR

(71) Applicant: Kenneth L. Beechie, University Place, WA (US)

(72) Inventor: Kenneth L. Beechie, University Place, WA (US)

(21) Appl. No.: 16/664,580

(22) Filed: Oct. 25, 2019

(51) Int. Cl. F16L 37/00; D06F 58/20

(52) U.S. Cl. CPC F16L 37/004; F16L 37/26; D06F 58/20

(57) ABSTRACT

A clothes dryer vent connection system 10 includes a vent housing 14 that has a forward inlet for receiving the dryer exhaust and a side outlet for routing the dryer exhaust to an outlet hose. The vent housing 14 includes a flat forward face 18 with a center hole 16 that can be placed in registry with the center opening of a magnetic boot 46 of a connector 24, which is attachable to a clothes dryer vent tube 26. The vent housing 14 is positioned in fixed location so that the clothes dryer vent tube 26 is in alignment with the housing opening 16. As such, the connector 24 attached to the dryer vent tube is also in registry with the housing opening. A secure connection is achieved by placing the magnetic boot 46 of the connector 24 against the housing front face 18 with the center of the boot section 46 aligned with the opening 16 of the vent housing front face 18.

### BACKGROUND

The present application pertains to a clothes dryer ventilation system wherein a connection system connects the exhaust vent of a clothes dryer to the exterior ambient.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with an embodiment of the present disclosure, a clothes dryer vent connection system connects a clothes dryer to the ambient, with the connection system comprising:

(a) a vent housing comprising:

a front surface having an inlet opening therein;

an outlet disposed transversely to the inlet opening and in communication with the inlet opening, the outlet directing output air from a clothes dryer to the ambient; and

a mounting system for mounting the vent housing in stationary location;

(b) as well as a connector for interconnecting a vent tube of the clothes dryer to the vent housing, the connector comprising:

a flexible magnetic boot;

an inlet sleeve projecting from the boot to engage the vent tube on the clothes dryer; and

the boot magnetically attachable to the vent housing front surface to interconnect the opening of the vent housing front surface with the inlet sleeve of the connector.

In any embodiment described herein, the vent housing comprising a passageway between the inlet opening and the outlet of the vent housing.

In any embodiment described herein, the passageway between the inlet opening and the outlet is supported in stationary position by the vent housing.

In any embodiment described herein, the vent housing comprising walls that enclose the tubular passageway.

In any embodiment described herein, the mounting system for mounting the vent housing comprises mounting tabs projecting from the vent housing.

In any embodiment described herein, the mounting system for mounting the vent housing comprising a mounting plate mountable to a stationary structure and an attachment for attaching the mounting plate to the vent housing.

In any embodiment described herein, the attachment is selected from the group including a magnet, an adhesive, hooks and loops.

In any embodiment described herein, the magnetic boot of the connector comprising elastic material having an opening formed therein to snugly encircle the inlet sleeve of the connector.

In any embodiment described herein, the portion of the elastic material of the boot that encircles the inlet sleeve of the connector forming a band extending snugly around the inlet sleeve.

In any embodiment described herein, the inlet sleeve having a flange projecting from the inlet sleeve to overlie the elastic material of the boot at the opening of the elastic material of the boot.

In any embodiment described herein, the inlet sleeve of the connector having a flange projecting from the sleeve to overlie the opening of the elastic material.

In any embodiment described herein, magnets are attached to the boot to magnetically connect the boot with the housing front surface.

In any embodiment described herein, the magnets extend along the perimeter of the boot.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an isometric view of a clothes dryer vent connection system in accordance with the present disclosure;

FIG. 2 is a view similar to FIG. 1 with components of the connection system exploded away;

FIG. 3 is an isometric view from the back side of a vent housing of the vent connection system;

FIG. 4 is a view similar to FIG. 3 but looking upwardly from the bottom of the back side of the vent housing;

FIG. 5 is a view similar to FIG. 3 but showing the connector portion of the connection system spaced away from the vent housing; and

FIG. 6 is a top cross-sectional view of the vent connection system of the present disclosure.

### DETAILED DESCRIPTION

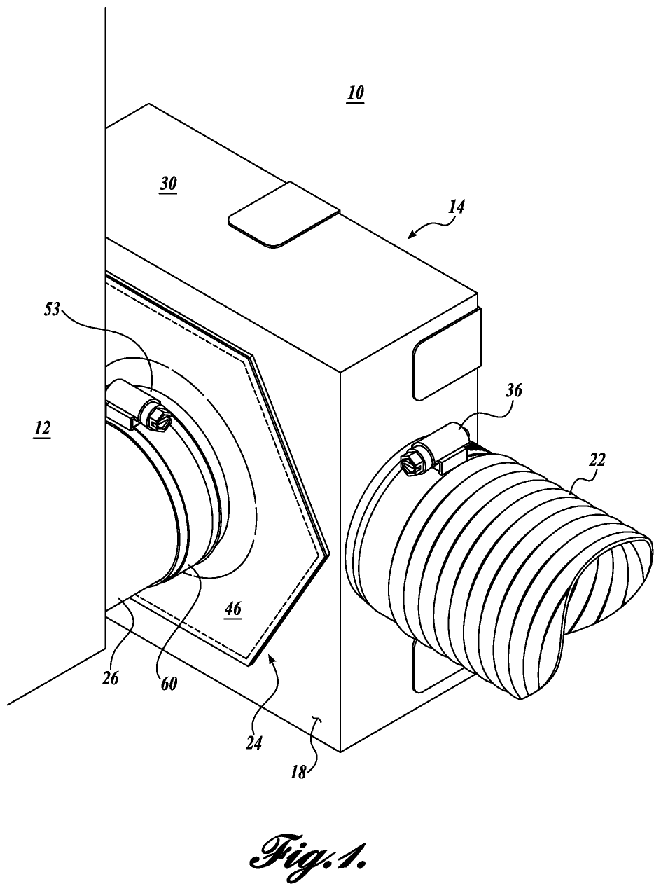

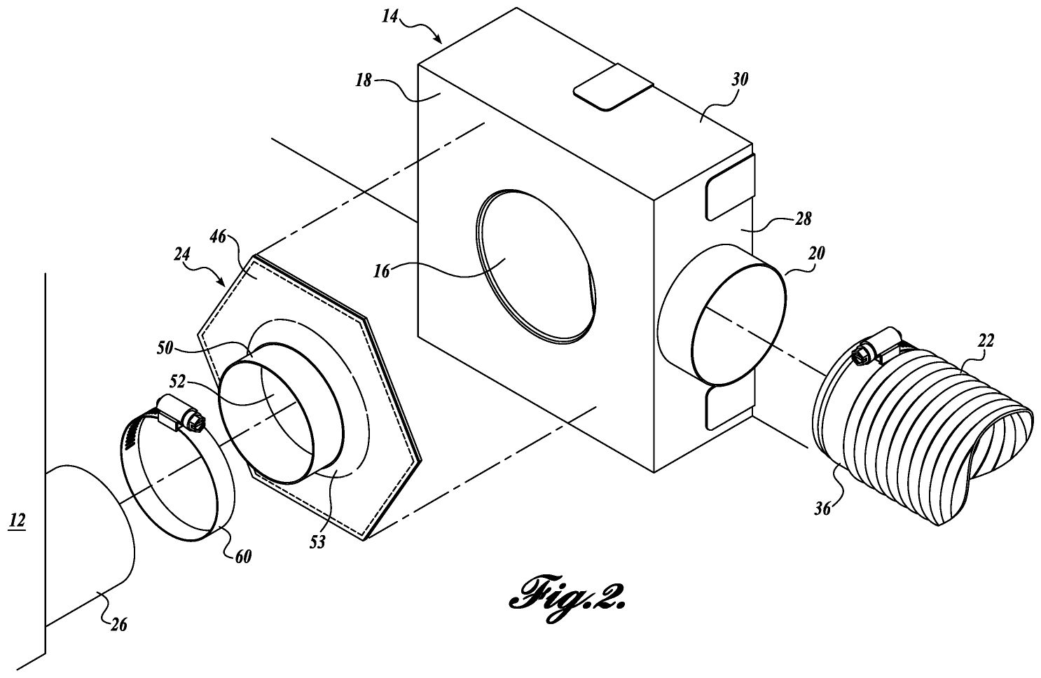

Referring initially to FIGS. 1 and 2, a clothes dryer vent connection system 10 is disclosed for connecting the exhaust from a clothes dryer 12 to the ambient. The connection system includes in basic form a vent housing 14 having an inlet opening 16 located centrally on the forward surface or face 18 of the housing. A side outlet 20 projects from the housing for connection to an outlet hose 22 leading to the exterior ambient. A connector 24 is designed to be coupled to a standard vent tube 26 which projects from the clothes dryer 12. The connector 24 includes a flexible boot section 46 that is magnetized so that the connector will securely detachably engage with the face 18 of the vent housing 14 when the clothes dryer 12 is properly positioned relative to the vent housing. In this manner, the clothes dryer exhaust can be conveniently routed to the exterior ambient when the clothes dryer is positioned in an installed location, and also can be conveniently pulled outwardly away from its installed position for cleaning, service, etc., and thereafter conveniently replaced in position with the exhaust from the dryer and routed to the ambient by simply re-positioning the dryer so that the connector boot section 46 is in face-to-face relationship with the forward surface or face 18 of the vent housing 14.

Next, describing the clothes dryer vent connection system 10 in greater detail, the vent housing 14 is constructed in a rectangular shape with substantially square front face or wall 18, opposed side walls 28, and top and bottom walls 30 and 32. Although the housing 14 is shown in rectangular shape, it may be in other shapes, for example, semi-circular, pentagonal, hexagonal, octagonal, etc.

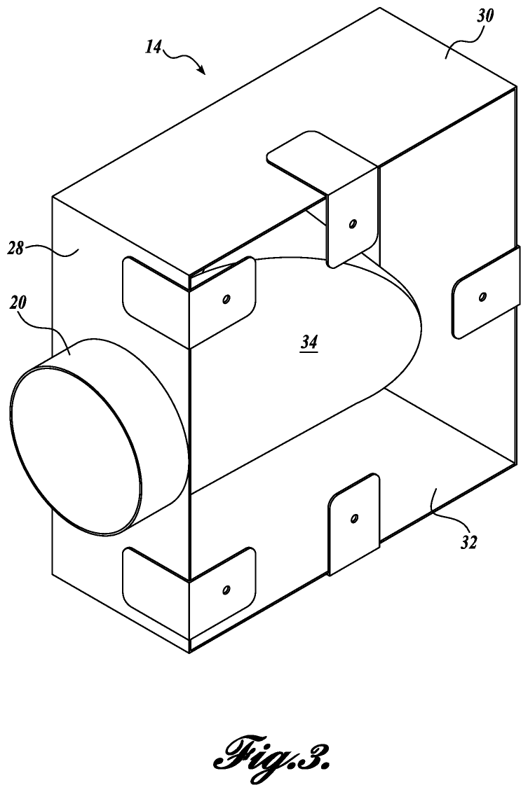

The housing 14 is constructed of a circular opening 16 in front face or wall 18. The opening 16 is in fluid flow communication with a transverse housing outlet 20 which projects from side wall 28. As shown in FIGS. 3-6, a tube or pipe 34 extends between opening 16 and the outlet 20 to form a direct, closed passageway therebetween. As such, the back side of the housing 14 can be opened as shown in FIGS. 3-5.

In an alternative construction, the back side of the vent housing 14 can be closed off to form the vent housing as a sealed unit. In that situation, tube 34 need not be used, rather a short sleeve or collar can project from the side wall 28 of the housing to serve as the outlet 20.

The outlet 20 is connectable to an outlet hose 22 leading to the exterior ambient in a standard manner A band clamp 36 can be employed to securely connect the end of the outlet hose 22 to the vent housing outlet 20.

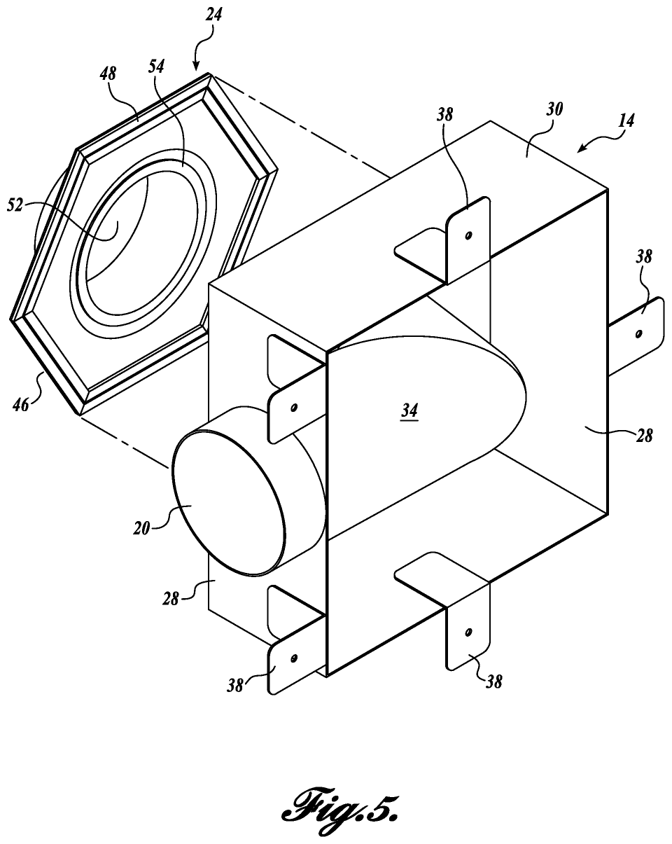

It is advantageous that the vent housing 14, once properly located, remain in stationary position. This can be accomplished in at least several ways. For example, as shown in FIG. 5, tabs 38 can be mounted to the side walls 28, top wall 30, and bottom wall 32 to provide flanges to bear against a wall positioned behind the clothes dryer 12. If the vent housing 14 is to be positioned on the floor, the tab 38 attached to the bottom wall 32 can simply be bent over on itself so as to not interfere with setting the vent housing on the floor. Through holes are provided in the tabs 38 for receiving fasteners for attaching the tabs 38 to the mounting wall.

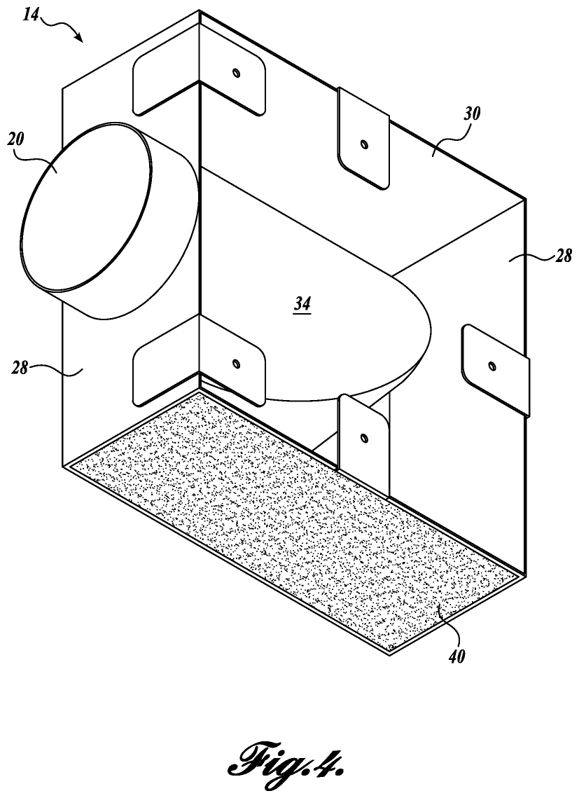

As another option, the vent housing 14 can be secured in place by using a hook and loop fastening system. In this regard, a strip 40 of hooks can be adhered to the underside of the bottom wall 32 of the vent housing, see FIG. 4. A corresponding strip of loops may be adhered to the floor behind the clothes dryer 12 thereby to securely position the vent housing 14 in place.

As a further alternative, a magnetic strip, not shown, can be placed on the floor behind the clothes dryer 12 at the appropriate location, for example, by using an appropriate adhesive or a hook and loop system or with hardware fasteners. Thereafter, the vent housing 14, being metallic, can simply be placed over the magnet thereby to securely position the vent housing in place.

As a further alternative, an adhesive could be applied to the underside of the bottom wall 32 to adhere the vent housing 14 to the floor behind the clothes dryer 12. Adhesives are commercially available that will securely and permanently position the vent housing in place.

It is to be understood that the vent housing can be secured in place by using both a system for securing the vent housing to the floor as described above, as well as using the tabs 38 to attach the vent housing to the wall. In this regard the tabs can be attached to the wall with hardware members as described above. Alternatively, the tabs can be attached to the wall using other means, such as with a loop and hook system similar that described above to attach the bottom wall 32 of the vent housing to the floor. A patch of strip of hooks or loops can be attached to the surfaces of tabs facing the mounting wall, and the other of the hooks and loops can be attached to the wall.

Next, specifically referring to FIGS. 1, 2, 5 and 6, connector 24, as noted above, is used to connect the clothes dryer vent tube 26 with the vent housing 14. To this end, the connector 24 is constructed with a generally planar, flexible, magnetic boot section 46 which is in the shape of a hexagon but can be of other shapes, including, for example, square, pentagonal, octagonal, round or oval.

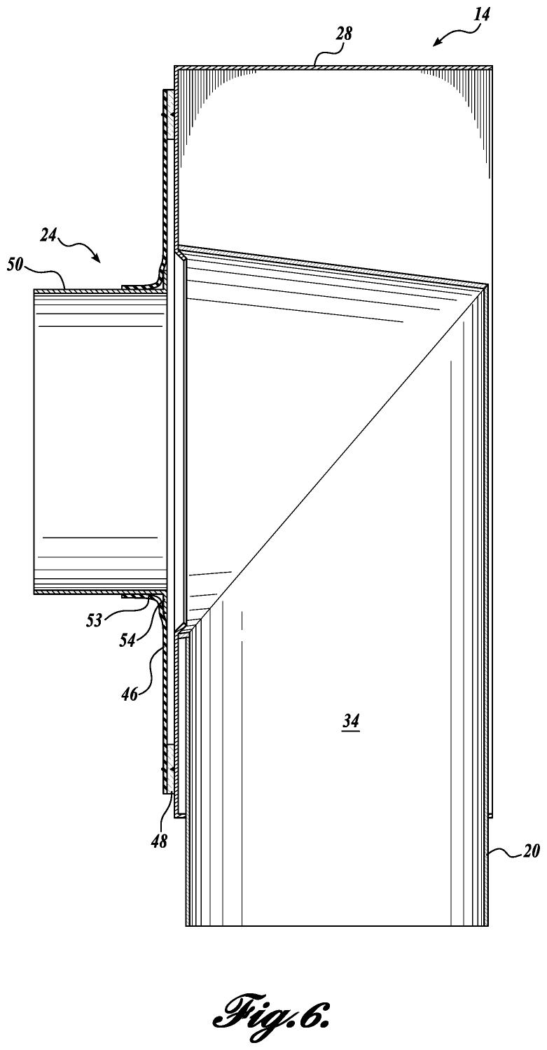

The boot section 46 is composed of a flexible elastic material to which magnets 48 are attached or incorporated. As shown in FIGS. 5 and 6, the magnets 48 extend along the perimeter of the boot section 46 thereby to form a closed hem or rim so that when the boot section 46 is attached to the housing face 18, a sealed connection is established with the housing 14 and an inlet sleeve 50 that projects outwardly from the boot section 46 towards the dryer 12.

Of course, the boot section 46 and magnet 48 can be of other constructions. For example, the magnets 48 can be embedded within a hem formed by the boot section 46. What is important is that a sealed connection occur between the boot section 46 and the housing face 18.

A central opening 52 is formed in the boot section 46 so that the boot section can snugly fit around the exterior circumference of the inlet sleeve 50. In this regard, the nominal size of the opening 52 can be smaller than the exterior diameter of the sleeve 50 so that a portion of the flexible and elastic material comprising the boot section overlies the inlet sleeve to thereby form a tight band 53 that snugly encircles and seals relative to the exterior of the inlet sleeve, see FIG. 6.

Moreover, by constructing the inlet sleeve 50 with a flange 54 disposed exterior to the side of the boot section 46 facing the vent housing 14, the boot section 46 is securely retained on the inlet sleeve 50. The flange 54 serves to prevent the boot section 46 from sliding off the adjacent end of the inlet sleeve. The flange can be integrally formed with the sleeve 50 or separately constructed and then attached to the sleeve by, for example, spot welding. As such, it is not necessary to employ a band clamp or other attachment device for retaining the boot section 46 engaged with the inlet sleeve 50. The flange 54 can be a flat flange that extends transversely to the length of the inlet sleeve 50 or the flange can be of other cross-sectional shapes. For example, the flange 54 can be of curved or circular cross-section, whether integrally formed with the sleeve or separately formed from the sleeve.

As shown in FIG. 1, the inlet sleeve 50 is attachable to the dryer vent tube 26 by use of a band clamp 60 or other fastening device.

The clothes dryer vent connection system 10 can be conveniently installed by attaching the connector 24 to the clothes dryer vent tube 26 using the band clamp 60. Next, the vent housing 14 is placed on the floor behind the dryer with the housing outlet 20 pointing to the exterior outlet location in the utility room or other location where the clothes dryer is located. As shown in FIGS. 1 and 2, typically an outlet hose 20 is connected to an outlet tube (not shown) extending through an exterior wall of the house or building in which the clothes dryer is located.

The dryer is then positioned close to the position of the vent housing. The vent housing can be simply moved side to side so that it is in alignment with the center of the boot 46 of the connector 24. Thereafter, the dryer is retracted or slid away so that the vent housing 14 can be permanently positioned using, for example, one of the methods as described above. Once this has occurred and the outlet hose 22 is secured to vent housing outlet 20, then the dryer can be simply pushed back into place so that the magnetized boot 46 securely attaches to the vent housing forward face 18. This creates a secure connection between the clothes dryer vent tube 26 and the outlet hose 22 so that dryer exhaust does not leak out to the interior of the house or dwelling where the clothes dryer is located, but rather the dryer exhaust is routed to the exterior ambient.

If it is desired to service the dryer, or perhaps clean behind the dryer, the dryer can simply be move forwardly in the direction away from the adjacent wall behind the dryer. As a result, the magnetic boot 46 is simply separated from the vent housing 14. Once the servicing of the dryer has been completed or the cleaning behind the dryer finished, etc., the dryer can be simply pushed back into place, whereby the boot 46 will again magnetically attach to the vent housing front face in a sealed, secure manner.

While illustrative embodiments have been illustrated and described, it will be appreciated that various changes can be made therein without departing from the spirit and scope of the invention.

The embodiments of the invention in which an exclusive property or privilege is claimed are defined as follows:

1. A clothes dryer vent connection system for connecting a clothes dryer to the ambient, comprising:
(a) a vent housing comprising:
a front surface having an inlet opening therein;
an outlet disposed transversely to the inlet opening and in communication with the inlet opening, the outlet directing output air from a clothes dryer to the ambient; and
a mounting system for mounting the vent housing in stationary location;
(b) a connector for interconnecting a vent tube of the clothes dryer to the vent housing, the connector comprising:
a flexible magnetic boot;
an inlet sleeve projecting from the boot to engage the vent tube on the clothes dryer; and
the boot magnetically attachable to the vent housing front surface to interconnect the opening of the vent housing front surface with the inlet sleeve of the connector.

2. The connection system according to claim 1, wherein the vent housing comprising a passageway between the inlet opening and the outlet of the vent housing.

3. The connection system according to claim 2, wherein the passageway between the inlet opening and the outlet is supported in stationary position by the vent housing.

4. The connection system according to claim 3, wherein the vent housing comprising walls that enclose the tubular passageway.

5. The connection system according to claim 1, wherein the mounting system for mounting the vent housing is selected from the group including mounting tabs projecting from the vent housing, a hook and loop system, a magnet, an adhesive.

6. The connection system according to claim 1, wherein the mounting system for mounting the vent housing comprising a mounting plate mountable to a stationary structure and an attachment for attaching the mounting plate to the vent housing.

7. The connection system according to claim 6, wherein the attachment is selected from the group including a magnet, an adhesive, hooks and loops.

8. The connection system according to claim 1, wherein the magnetic boot of the connector comprising elastic material having an opening formed therein to snugly encircle the inlet sleeve of the connector.

9. The connection system according to claim 8, wherein the portion of the elastic material of the boot that encircles the inlet sleeve of the connector forming a band extending snugly around the inlet sleeve.

10. The connection system according to claim 9, wherein the inlet sleeve having a flange projecting from the inlet sleeve to overlie the elastic material of the boot at the opening of the elastic material of the boot.

11. The connection system according to claim 1, wherein the inlet sleeve having a flange projecting from the inlet sleeve to overlie the elastic material of the boot at the opening of the elastic material of the boot.

12. The connection system according to claim 8, wherein the inlet sleeve of the connector having a flange projecting from the sleeve to overlie the opening of the elastic material.

13. The connection system according to claim 1, wherein magnets are attached to the boot to magnetically connect the boot with the housing front surface.

14. The connection system according to claim 13, wherein the magnets extend along the perimeter of the boot.
